(19) United States
(12) Patent Application Publication
(10) Pub. No.: US 2017/0076297 A1
(43) Pub. Date: Mar. 16, 2017

(54) POLARITY TURN-AROUND TIME OF SOCIAL MEDIA POSTS

(71) Applicant: salesforce.com, inc., San Francisco, CA (US)

(72) Inventor: Hao Dong, Warren, NJ (US)

(21) Appl. No.: 14/850,735

(22) Filed: Sep. 10, 2015

(51) Int. Cl. G06Q 30/02

(52) U.S. Cl. CPC G06Q 30/0201; G06Q 50/01

(57) ABSTRACT

The technology disclosed solves the technical problem of measuring efficiency and effectiveness of online social engagements relating to user experience management. The technical solution disclosed herein entails offering a technical measure for user experience and satisfaction with the objective of converting online detractors into online promoters. In particular, this technical measure quantifies changes in user opinion polarity based on the time taken to turn negative user commentary into positive user commentary during an online social engagement. In some implementations, the disclosed technical measure is a productivity measure that represents user interaction and service skills of a company representative. In other implementations, the disclosed technical measure is a return on investment (ROI) measure used by company executives to learn the average time span taken to flip an online detractor into an online promoter during a user experience operation and estimate the operation's success.

### FIELD OF THE TECHNOLOGY DISCLOSED

The technology disclosed relates generally to online social engagements, and in particular to providing a technical metric that measures efficiency and effectiveness of the online social engagements.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

The technology disclosed solves the technical problem of measuring efficiency and effectiveness of online social engagements relating to user experience management. The technical solution disclosed herein entails offering a technical measure for user experience and satisfaction with the objective of converting online detractors into online promoters. In particular, this technical measure quantifies changes in user opinion polarity based on the time taken to turn negative user commentary into positive user commentary during an online social engagement. In some implementations, the disclosed technical measure is a productivity measure that represents user interaction and service skills of a company representative. In other implementations, the disclosed technical measure is a return on investment (ROI) measure used by company executives to learn the average time span taken to flip an online detractor into an online promoter during a user experience operation and estimate the operation's success.

The popularity of online social networks has cemented Internet as the platform for personal communication, information sharing and opinion publishing. Tools characteristic of Internet 2.0's online social networks like Twitter, Facebook and YouTube have created an extra source of “Big Data”, a term coined as part of a NASA project to describe work involving the visualization of datasets generated by supercomputers. Big data now often exceed petabytes in size. For instance, approximately 400 million tweets are posted every day on Twitter.

These online social networks provide an unprecedented opportunity to study user communication in real-time, which are exposed on open platforms for third party developers through their application programming interfaces (APIs), such as the Chatter API, Facebook API (e.g., Open Graph), Twitter API (e.g., Firehose, Sprinkler), Yahoo API (e.g., Boss) etc. These APIs offer never before access to vast reserves of real-time user thoughts and are now forming the foundation of many futuristic analytics.

Opinions posted on online social networks are of great influence and often determine how people make selections and purchasing decisions. Companies monitor online social networks closely via the above discussed APIs to gage how users perceive the brands that represent their products and services. Moreover, many companies launch user experience operations to actively engage in online conversations with users on social networks. These operations involve responding to user complaints made on social media sites. Other times, they involve identifying influential users and marketing to them to enhance recognition of company brands.

Currently, there is no technical metric that allows companies to determine if their user experience operations are working In particular, there is no technical metric that captures online social engagements and measures the impact of those engagements on user experience and how efficiently those impacts are brought about.

Therefore, systems and methods are needed that provide companies the ability to automatically measure the efficiency and effectiveness of online user engagements made in response to online user grievances. Increased user responsiveness with improved overall user satisfaction and greater user retention and profitability may result.

### SUMMARY

A simplified summary is provided herein to help enable a basic or general understanding of various aspects of exemplary, non-limiting implementations that follow in the more detailed description and the accompanying drawings. This summary is not intended, however, as an extensive or exhaustive overview. Instead, the sole purpose of this summary is to present some concepts related to some exemplary non-limiting implementations in a simplified form as a prelude to the more detailed description of the various implementations that follow.

The technology disclosed solves the technical problem of measuring efficiency and effectiveness of online social engagements relating to user experience management. The technical solution disclosed herein entails offering a technical measure for user experience and satisfaction with the objective of converting online detractors into online promoters. In particular, this technical measure quantifies changes in user opinion polarity based on the time taken to turn negative user commentary into positive user commentary during an online social engagement. In some implementations, the disclosed technical measure is a productivity measure that represents user interaction and service skills of a company representative. In other implementations, the disclosed technical measure is a return on investment (ROI) measure used by company executives to learn the average time span taken to flip an online detractor into an online promoter during a user experience operation and estimate the operation's success.

Other aspects and advantages of the technology disclosed can be seen on review of the drawings, the detailed description and the claims, which follow.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 depicts an exemplary user experience management environment.

FIG. 2 illustrates one implementation of a user engagement console used to run a user experience operation.

FIG. 3 is one implementation of an online social engagement with a user during the user experience operation illustrated in FIG. 2.

FIG. 4 shows a high level view of the data model of a system in accordance with an implementation of the technology disclosed.

FIG. 5 illustrates social media data being stored in a Cassandra data model in accordance with an implementation of the technology disclosed.

FIG. 6 shows one implementation of a flowchart of measuring impact of social engagement on turn-around of social media opinion polarity.

FIG. 7 is a block diagram of an exemplary multi-tenant system suitable for integration with the user experience management environment of FIG. 1 in accordance with one or more implementations of the technology disclosed.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The discussion is organized as follows. First, an explanation of terminology that will be used throughout the discussion is provided, followed by an introduction describing some of the technical problems addressed and technical solutions offered by various implementations. Then, a high-level description of some implementations will be discussed at an architectural level. Further, some user interface views used by some implementations will be presented. Next, some data models used by various implementations are described. Also, more focused actions for implementing the system, together with tracking methods, quantification processes, data models and application definitions are discussed. Lastly, some particular implementations are discussed.

### Terminology

Online Social Network: An “online social network” is defined as any combination of software, protocols and/or hardware configured to allow a community of user or individuals and/or other entities to share information, resources and the like via a computer network (such as the Internet). An online social network uses a platform like a website, blog or forum to foster interaction, engagement and information sharing. Some examples of an online social network include Facebook®, Twitter®, YouTube®, Flickr®, Picasa®, Digg®, RSS®, Blogs®, Reddit®, LinkedIn®, Wikipedia®, Pinterest®, Google Plus+®, MySpace®, Bitly® and the like. This application, in some implementations, interchangeably refers to “online social network” as “social network”, “social media site”, “social networking service”, “social media source” and “social networking entity”, and vice-versa.

Social Media Data: “Social media data” are defined as any content authored, created, generated, posted or shared over one or more online social networks. Social media data includes social media objects, which can be text, still images, videos, comments, posts, messages, blogs, news, articles and stories. This application, in some implementations, interchangeably refers to “social media data” as “data” or “social data stream”, and vice-versa.

Influence Level: An “influence level” is defined as the extent to which someone who posts a social media post is likely to shape and/or control other users' perception who consume that social media post. In some implementations, an influence level can be expressed as a numeric value, like a Klout score®, or any other alphanumeric value.

Commentator: A “commentator” is defined as a user who authors, creates, generates, posts or shares social media objects over one or more online social networks. This application, in some implementations, interchangeably refers to a “commentator” as a “user” or “first user”, and vice-versa.

Promoter: A “promoter” is defined as a user who generates positive commentary or raves about a brand, according to one implementation. In some implementations, such raves enhance brand recognition by spreading positive word of mouth about the brand on online social networks. In another implementation, a promoter is defined as a user who expresses satisfactory commentary during a user engagement. In yet another implementation, a promoter is defined as a user whose social media posts have a positive and/or neutral polarity.

Detractor: A “detractor” is defined as user who generates negative commentary or rants about a brand. In some implementations, such rants diminish brand recognition by spreading negative word of mouth about the brand on online social networks. In another implementation, a detractor is defined as a user who expresses unsatisfactory commentary during a user engagement. In yet another implementation, a detractor is defined as a user whose social media posts have a negative and/or mixed polarity.

User Experience Operation: A “user experience operation” is defined as an orchestrated effort, usually on behalf of a company, to engage with users on one or more online social networks. In some cases, the engagement involves responding to user's social media posts about a brand of the company that represents a product or service of the company. In other cases, the engagement involves responding to user's online grievances and/or concerns or expressions of unsatisfactory experience relating to a product or service offered by the company and attempting to resolve them through the engagement.

User Experience Management: “User experience management” is defined as the application of user experience operations on online social networks.

Online Social Engagement: An “online social engagement” is defined as a collection of social media posts in the form of an ordered conversational chain. In one implementation, a social media engagement is uniquely identified by an “engagement_key”. In some implementations, a “global polarity” of an online social engagement that includes a plurality of social media posts is the polarity of the latest social media post in the social engagement.

Application Programming Interface: An “application programming interface (API)” is defined as a packaged collection of code libraries, methods and fields that belong to a set of classes, including its interface types. The API defines the way that developers and programmers can use the classes for their own software development, just by importing the relevant classes and writing statements that instantiate the classes and call their methods and fields. In another implementation, an API is a source code based specification intended to be used as an interface by software components to communicate with each other. An API can include specifications for routines, data structures, object classes and variables. Basically, an API provides an interface for developers and programmers to access the underlying platform capabilities and features of online social networks. For example, Twitter's Search API involves polling Twitter's data through a search or username. Twitter's Search API gives developers and programmers access to data set that already exists from tweets which have occurred. Through the Search API, developers and programmers request tweets that match search criteria. The criteria can be keywords, usernames, locations, named places, etc. In another example, Twitter's Streaming API is a push of data as tweets are posted in near real-time. With Twitter's Streaming API, developers and programmers register a set of criteria (e.g., keywords, usernames, locations, named places, etc.) and as tweets match the criteria, they are pushed directly to the developers and programmers. In yet another example, Twitter Firehose pushes data to developers and programmers in near real-time and guarantees delivery of all the tweets that match the set criteria.

Identification: As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “specify” is used herein to mean the same as “identify.”

### Introduction

We describe a system and various implementations of measuring efficiency and effectiveness of online social engagements relating to user experience management. The technical solution disclosed herein entails offering a technical measure for user experience and satisfaction with the objective of converting online detractors into online promoters. In particular, this technical measure quantifies changes in user opinion polarity based on the time taken to turn negative user commentary into positive user commentary during an online social engagement. In some implementations, the disclosed technical measure is a productivity measure that represents user interaction and service skills of a company representative. In other implementations, the disclosed technical measure is a return on investment (ROI) measure used by company executives to learn the average time span taken to flip an online detractor into an online promoter during a user experience operation and estimate the operation's success.

Today, with the growing use of mobile devices constantly connected to the Internet, the nature of user-generated thoughts and opinions has become real-time. Users share thoughts and discuss products and services on Facebook and Twitter. Thus, in today's increasingly competitive marketplace, companies cannot afford to lose users who are expressing their opinions about products and services. Even worse, a poor reputation among existing users often blocks companies from winning new opportunities. A management metric called the “Net Promoter Score” is now being used as the worldwide standard for organizations to measure, understand and improve their user experience. As a result, companies like USAA™, Discover™, Apple™ and Amazon™ employ highly organized social media strategies to enhance their Net Promoter Scores.

To positively and directly affect Net Promoter Scores, companies communicate with users on a variety of social media networks where users express opinions and provide commentary about the companies and their products and services. This is sometimes referred to as “user experience management” or “user satisfaction management”. A glance at the social media profiles of major brands reveals numerous interactions that could fit into this framework. Detractors who tweet their complaints at an airline or insurance company may simply be looking for a resolution to an immediate concern, but they are also expressing willingness to be publicly, pleasantly surprised by a company's response. Conversations with this type of unhappy user are found on most highly active corporate Twitter streams.

Companies have implemented processes and operations to respond to users that talk about their brands. In many cases, this involves communicating with users who would not otherwise become promoters, but who do become so following a social media experience. In other cases, it involves communicating with detractors who are willing to be convinced if their issues are readily resolved or former promoters who have had bad experiences, or neutrals primed to be impressed by a great user experience.

However, currently there is no technical metric that calculates whether such processes and operations are effective or the extent to which such operations remedy user issues or how swiftly they convert a detractor into a promoter. Specifically, an efficiency and effectiveness metric is needed that measures productivity of online social engagements initiated by companies to resolve user grievances.

By measuring user opinion turn-around time, an opportunity arises to motivate companies to deliver rewarding experiences that users will want to talk about on social networks and enable companies to improve their Net Promoter Scores which can be automatically reflected in brand recognition.

The technology disclosed relates to measuring impact of social engagement on turn-around of social media opinion polarity by using computer-implemented systems. The technology disclosed can be implemented in the context of any computer-implemented system including a database system, a multi-tenant environment, or a relational database implementation like an Oracle™ compatible database implementation, an IBM DB2 Enterprise Server™ compatible relational database implementation, a MySQL™ or PostgreSQL™ compatible relational database implementation or a Microsoft SQL Server™ compatible relational database implementation or a NoSQL non-relational database implementation such as a Vampire™ compatible non-relational database implementation, an Apache Cassandra™ compatible non-relational database implementation, a BigTable™ compatible non-relational database implementation or an HBase™ or DynamoDB™ compatible non-relational database implementation.

Moreover, the technology disclosed can be implemented using two or more separate and distinct computer-implemented systems that cooperate and communicate with one another. This technology can be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

In addition, the technology disclosed can be implemented using different programming models like MapReduce™, bulk synchronous programming, MPI primitives, etc. or different stream management systems like Apache Storm™, Apache Spark™, Apace Kafka™, Truviso™, IBM Info-Sphere™, Borealis™ and Yahoo! S4™.

### User Experience Management Environment

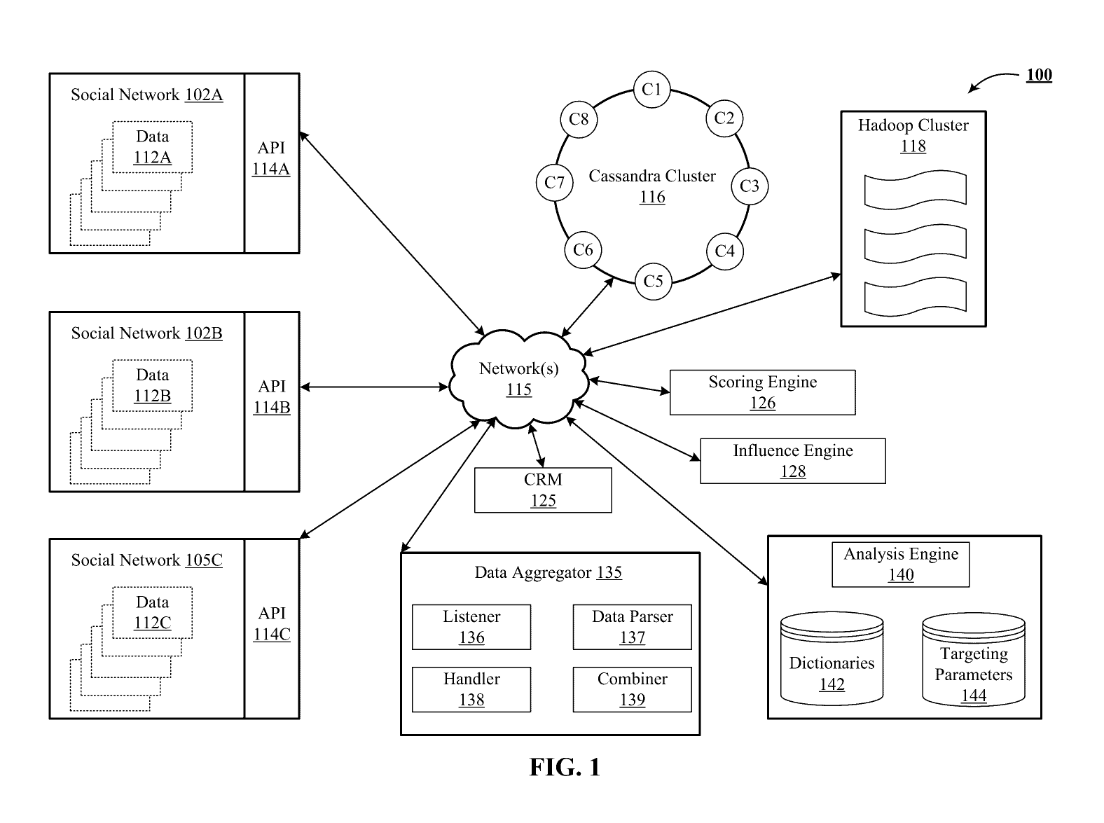

We describe a system and various implementations of measuring efficiency and effectiveness of online social engagements relating to user experience management. The system and processes will be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the system will be described in greater detail.

FIG. 1 includes the environment 100. The environment 100 includes social networks 102A-C, APIs 114A-C, networks(s) 115, Cassandra cluster 116, Hadoop cluster 118, user relationship management (CRM) system 125, scoring engine 126, influence engine 128, data aggregator 135 and analysis engine 140. The social networks 102A-C include social media data 112A-C. Data aggregator 135 includes listener 136, data parser 137, handler 138 and combiner 139. Analysis engine 140 uses dictionaries 142 and targeting parameters 144.

The interconnection of the elements of environment 100 will now be described. The network(s) 115 couples the social networks 102A-C via the APIs 114A-C, the Cassandra cluster 116, the Hadoop cluster 118, the CRM system 125, the scoring engine 126, the influence engine 128, the data aggregator 135 and the analysis engine 140, all in communication with each other (indicated by solid double-arrowed lines). The actual communication path can be point-to-point over public and/or private networks. Some items, such as social media data 112A-C, might be delivered indirectly, e.g. via an application store (not shown). All of the communications can occur over a variety of networks, e.g. private networks, VPN, MPLS circuit, or Internet, and can use appropriate APIs and data interchange formats, e.g. REST, JSON, XML, SOAP and/or JMS. All of the communications can be encrypted. The communication is generally over a network such as the LAN (local area network), WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, Wi-Fi and WiMAX. Additionally, a variety of authorization and authentication techniques, such as username/password, OAuth, Kerberos, SecureID, digital certificates and more, can be used to secure the communications.

Having described the elements of FIG. 1 and their interconnections, the system will now be described in greater detail.

FIG. 1 depicts an exemplary user experience management environment 100. In particular, there are multiple social networks 102A-C depicted on the left, each of which are communicably interfaced with network(s) 115 via their respective APIs 114A-C (Application Programming Interfaces) through which social media data 112A-C for the respective social networks 102A-C may be observed, listened to, monitored, tracked, collected, aggregated, assembled, retrieved, etc. Such data 112A-C may be, for example, user activity data pertaining to the users' activities, comments, connections, likes, tweets, reviews, and so forth which is generated within the respective social networks 102A-C as the user engages with such sites.

Thus, social network 102A is exposed through API 114A and its social media data 112A represents users, entities, concepts, themes, discussions, trends, and so forth, based on the activity and interactions of the users within social network 102A. Similarly, social network 102B includes data 112B exposed via API 114B and social network 102C includes data 112C exposed via API 114C. Three social networks 102A-C are depicted but there may be a different number of social networks, including a single social network (e.g., Mashable™, StumbleUpon™) within which aggregation takes place amongst multiple social networks or users or other sources within the single social network.

Data aggregator 135 is depicted separately in the particular implementation illustrated in FIG. 1, but may be part of, or located with the analysis engine 140 in other implementations. Data aggregator 135 includes listener 136 capable of listening to streams and data flows originating at the social networks 102A-C by connecting with their respective APIs 114A-C via the public Internet. In some implementations, listener 136 includes heterogeneous instances responsible for the intake of data 112A-C from different social networks 102A-C. As depicted here, the social networks 102A-C can be accessed using exposed APIs 114A-C, such as the Chatter API, Facebook API (e.g., Open Graph), Twitter API (e.g., Twitter Firehose, Sprinklr, Twitter Search API, Twitter Streaming API), Yahoo API (e.g., Boss) etc. to retrieve data 112A-C. Such information can include user's identities (sometimes referred to as user handles or user IDs and other times the users' actual names), content posted by a user to a respective feed on a social network service, social graph data, metadata including whether comments are posted in reply to a prior posting, events, news articles, and so forth.

Listener 136 listens to social media data such as Twitter tweets, Facebook pages, forums, Facebook insights, and so forth by referencing a database of keywords, phrases, locations, data formats, hashtags, and anything else that helps to focus the data eventually digested. Listener 136 listens for both structured data, such as known values and keywords returned from the APIs, and also listens for unstructured data, such as text in posts, comments, tweets, and so forth. The listener 136 discovers interesting data from the social networks 102A-C and available for reference by the listener 136, according to one implementation.

In some implementations, listener 136 includes a miner for performing a pull from the APIs 114A-C and a crawler for other social networks which do not expose a public API. In one implementation, to consume data from APIs 114A-C, listener 136 provides a push API with a valid endpoint. This endpoint can take the form of an HTTP/HTTPS server, a UDP socket, or a message queue listener (e.g. RabbitMQ, ActiveMQ, etc.). The listener 136 can also throttle messages as necessary to ensure none are dropped.

In one implementation, data aggregator 135 collects social media data 112A-C from social networks 102A-C. In some implementations, web crawlers are deployed to gather the social media data 112A-C and associated metadata. Data aggregator 135 further includes a combiner 139 which aggregates, combines, or otherwise joins the individualized data 112A-C from the respective social networks 102A-C into a single output or a single source which may be accessed, communicated, or consumed by another entity, such as the data parser 137 and analysis engine 140.

In an implementation, data aggregator 135 includes a social media handler component 138 configured to retrieve social media objects from one or more social networks 102A-C. According to an implementation, the social media handler component 138 can be configured to receive the social media objects over the network 115 and an application protocol layer, or other higher protocol layer, such as HTTP protocol layer, among many possible standard and proprietary protocol layers. These higher protocol layers can encode, package and/or reformat data for sending and receiving messages over a network layer, such as Internet Protocol (IP), and/or a transport layer, such as Transmission Control Protocol (TCP) and/or User Datagram Protocol (UDP).

The gathered data is processed and/or normalized (e.g., using stop-word removal) and the most frequent n-grams are detected to identify polarity-bearing terms. In one implementation, adjectives associated with each n-gram are identified as the opinion-bearing terms. In another implementation, opinion-bearing terms are extracted automatically (e.g., by providing a lexicon or training dataset to an extraction engine) and the adjectives are tagged with polarities (e.g. positive, negative, neutral or mixed).

In some instances, data includes structured data and functionality targets specific data constructs provided by the social networks. Non-structured data, such as free text, may also be provided by, and targeted back to, the social networks. Both structured and non-structured data are capable of being aggregated by data aggregator 135. For instance, the assembled data is stored in a semi-structured data format like a JSON (JavaScript Option Notation), BSON (Binary JSON), XML, Protobuf, Avro or Thrift object, which consists of string fields (or columns) and corresponding values of potentially different types like numbers, strings, arrays, objects, etc. JSON objects can be nested and the fields can be multi-valued, e.g., arrays, nested arrays, etc., in other implementations.

For instance, Twitter Firehose API (accessible via Twitter-affiliated companies like Datashift, nTweetStreamer, tiwwter4j) provides social media posts, called tweets, as a stream of JSON objects along with metadata about those tweets, including timestamp data about the tweets, user information, location, topics, keywords, retweets, followers, following, timeline, userline, etc. These JSON objects are stored in a schema-less or NoSQL key-value data-store like Apache Cassandra™, Google's BigTable™, HBase™, Voldemort™, CouchDB™, MongoDB™, Redis™, Riak™, Neo4j™, etc., which stores the parsed JSON objects using keyspaces that are equivalent to a database in SQL. Each keyspace is divided into column families that are similar to tables and comprise of rows and sets of columns.

In one implementation shown in environment 100, as real-time social data streams 112A-C are aggregated, they are stored in a NoSQL key-value column store distributed storage system 116 called Cassandra™. Data sent to Cassandra™ is spread out across many nodes or commodity servers C1-C8, connections to which can be made using a Java, Scala, Ruby, Clojure or Python based APIs (e.g., Hector, Pelops, CQL, Thrift, Phpcassa, PyCassa, etc.). Cassandra™ stores data in units called columns. Each column is a tuple, a list of associated data elements. The basic column format can be represented as (name, value, timestamp). For brevity, the timestamp, while an essential element of the column, is often not written. Thus, an example column may be written

(UserName, User—1). An optional level of hierarchy called a super column may incorporate any number of columns. Moving up a level, keys (sometimes referred to as rows) are tuples consisting of a name and one or more columns or super columns. An example key may be written (Status_Key, (UserName, User—1), (Logged_In, Y). Any number of keys may be grouped into a column family. Analogously, a group of column families is referred to as the keyspace, the final level of hierarchy. Two pseudocode representations of the relationship can be constructed as follows:
[keyspace] [column family] [key] [column]
[keyspace] [column family] [key] [super column] [column]

A more detailed description of distributed key-value storage systems is found in the following papers: Cassandra—A Decentralized Structured Storage System, Avinash Lakshman and Prashant Malik, 2009; Dynamo: Amazon's Highly Available Key-value Store, Giuseppe DeCandia, Deniz Hastorun, Madan Jampani, Gunavardhan Kakulapati, Avinash Lakshman, Alex Pilchin, Swaminathan Sivasubramanian, Peter Vosshall, and Werner Vogels, SOSP '07, Oct. 14-17, 2008; and Bigtable: A Distributed Storage System for Structured Data, Fay Chang, Jeffrey Dean, Sanjay Ghemawat, Wilson C. Hsieh, Deporah A. Wallach, Mike Burrows, Tushar Chandra, Andrew Fikes, and Robert E. Gruber, Operating Systems Design and Implementation (OSDI), 2006; all of which are incorporated by reference herein.

In other implementations, real-time social data streams 112A-C are stored in a Hadoop distributed file system (HDFS) like Hadoop cluster 118.

In an implementation, data parser 137 analyzes incoming data and identifies targetable concepts, keywords, events, handles, locations, demographics, psychographics, and so forth, within the data received. Parsing is the process of breaking up and analyzing a stream of text or other data sources into words, key words, phrases, locations, demographics, psychographics, symbols, user IDs, user handles, hashtags, memes, event and incident names, or other meaningful elements called “targetable parameters”. A list of targeting parameters 144 becomes input for further processing such as parting or text mining, for instance, by a matching engine (not shown). Parsing extracts meaning from available data. Tokenization may operate as a first step of parsing to identify granular elements (e.g., tokens) within a stream of data, but parsing then goes on to use the context that the token is found in to determine the meaning and/or the kind of information being referenced. Because data entering the data aggregator is not homogenous (e.g., there are many different sources in many different formats), certain implementations employ at least one data parser (e.g., 137) per data feed, and in some cases more than one.

To illustrate, consider that a first user may publish a status update to their Facebook wall stating: “I can't open any ExactTarget documents!” This may be provided as a record that contains the content only (e.g., the string) or may be part of a record with other relevant values such as the user's ID, the originating social network, a time stamp, IP address, device, other content, surrounding context, the venue in which the comment was posted (such as being posted on a wall, a comment section responsive to another post or article, a public tweet, shout out, or other public message, etc.).

Analysis engine 140 is similarly interfaced to network(s) 115 and may receive data 112A-C of the respective social networks 102A-C or may alternatively source the data 112A-C in a combined or aggregated form from data aggregator 135. Analysis engine 140 also uses targeting parameters 144 that identify brand names, brand social handles, brand usernames, brand URLs (uniform resource locators), brand domain names, common rant words/phrases, common rave words/phrases, etc. within the data received.

In an implementation, analysis engine 140 performs the so-called “deep linguistic analysis” on the social media data 112A-C to determine polarity of social media posts. In this case, analysis engine 140 uses grammar and language structure rules to analyze social media data 112A-C at the sentence level as well as at the phrase level within a sentence by identifying the different phrases like noun phrases (e.g., engineer), adjective phrases (e.g., easy), verb phrases (e.g., understands), adverbial phrases (e.g., yet) and others, along with their semantic dependencies and relationships. In another implementation, analysis engine 140 looks up every word of a social media post in one or more context dictionaries 142 to find important linguistic information coded for that word, including pre-determined polarities (e.g. positive, negative, neutral or mixed), reference to a brand name, abbreviation of a brand name, etc.

In one implementation, analysis engine 140 identifies a brand associated with a social media post by recognizing and classifying entities in the social media post using at least one of deep linguistic analysis, regular expressions based alphanumeric pattern detection and user dictionaries and natural extractor monolingual and multilingual dictionaries. This also includes detecting and extracting proper names (e.g., John Smith), numeric entities (e.g., phone numbers, bank accounts), alphanumeric entities (e.g., web addresses), social handles and hashtags (e.g., Twitter handle, Facebook usernames). In yet another implementation, a plurality of social media objects published by at least one social networking entity are scanned to identify a first social media object posted by a first user and relating to a brand associated with at least one of a product, an enterprise, a service, a person, a concept and a trackable object. In an implementation, the scanned social media objects include social media posts, messages, video and audio clips, image files and any other content posted by a plurality of users.

In one implementation, scoring engine 126 calculates polarity scores for the social media objects such that the more intense the feelings of the commentator about the subject, the higher or lower the score. In some implementations, this is achieved by detecting linguistic features such as the semantic strength of the vocabulary or the use of intensifiers like “really”, “very”, “great” “excellent”, “extremely” or “not”.

According to an implementation, a plurality of influence factors is used by influence engine 128 to determine whether and to what extent a first user is likely to be someone who shapes and/or controls how other users perceive or relate to a brand. For example, an influence factor can be related to a number of following users following the first user via at least one social networking entity because when the first user is followed by, and/or friends with, tens of thousands of following users who will potentially view the first user's posts, this fact is an indication that the first user is highly influential.

In an implementation, another influence factor is related to a social and/or professional status or attribute of a first user or of a following user, i.e., who is following the first user. For instance, when a following user's professional status or attribute indicates that she is the chief executive officer (CEO) of a rival of the brand, this fact can be an indication that the first user is highly influential because the rival's CEO is presumably interested in viewing the first user's posts. Another influence factor can be directed to a number and/or a social and/or professional status/attribute of second degree users following the following user, and whether a social media object is reposted by the following users to their respective following users. For example, when the first user or a following user is a film or music recording celebrity who is followed by millions of user fans, a first social media object posted by the first user can potentially reach the millions of user fans when the celebrity following user reposts the first social media object. In an implementation, another influence factor is directed to a leading user followed by the first user, and/or a status/attribute of the leading user.

In another implementation, an influence factor is related to reactions and comments to a social media object. For example, a first user is considered influential with respect to a brand when a first social media object posted by the first user generates numerous comments from following users and/or numerous users indicate that they agree with, or have an affinity toward, the first social media object. In an implementation, such a reaction is submitted when a user “likes” the first social media object and/or a comment relating to the first social media object. In addition, another influence factor is directed to how many other social media objects relating to the brand have been posted by the first user. For example, when the first user has posted hundreds of messages, images and audio/video clips relating to the brand, this fact can indicate that the first user is influential with respect to the brand.

Other influence factors can be defined and directed to a variety of subjects. For example, a non-exhaustive list of influence factors can be directed to:
whether the first user is an employee or a consumer of the brand;
whether the first user is an existing or prospective user of the brand;
whether the first user is an executive of an existing or prospective enterprise user of the brand;
whether the first user is unaffiliated with the brand;
the first user's position in the industry concerning the brand;
how frequently the first user posts social media objects relating to the brand;
whether the first user posts social media objects relating to rivals of the brand; and
other areas that can indicate whether and to what extent the first user is likely to be someone who shapes and/or controls how other users perceive or relate to the brand.

In an implementation illustrated in FIG. 1, a CRM system 125 includes components adapted for operating in management environment 100. The management environment 100, or an analog, can be provided by a node such as a CRM server node. The CRM system 125 can include an incoming and outgoing data handler component for receiving and transmitting information from and to the plurality of user system nodes via the network 115.

In an implementation, the CRM system 125 includes a data store for storing a plurality of data objects including a plurality of contact records, a plurality of account records, and/or other records (collectively CRM records). In some implementations, a CRM record can include, but is not limited to, a tuple corresponding to a user, a file, a folder, an opportunity, an account, an event, and/or any data object. The CRM system 125 can include a data manager component that can be configured to insert, delete, and/or update the records stored in the data store. In addition, the CRM system 125 can include a monitoring agent that is configured to monitor activities related to the CRM records. For example, the monitoring agent can be configured to track a user's post via a public or private social networking service, and/or a user's email client on the user's enterprise desktop computer, and to monitor updates to the contact records, event records, and/or any other CRM record(s) stored in the data store.

Aggregated data can additionally be used by the CRM system 125, such as is offered by salesforce.com, inc. For example, aggregated data can be used to identify opportunities, leads, contacts, and so forth, in the CRM system 125, or can be used to support marketing operations with products such as Radian6™, Buddy Media™ services, and the like. This CRM data can also then in turn be used to find these specific users again on these social networks, using matching tools provided by the social network providers. Additionally these could also be layered with specific targeting learnt from the aggregation and analysis by the data aggregator 135 and analysis engine 140 respectively.

In an implementation, user experience management environment 100 can be located in a cloud computing environment, and may be implemented as a multi-tenant database system. As used herein, the term multi-tenant database system refers to those systems in which various elements of hardware and software of the database system may be shared by one or more tenants. For example, a given CRM server may simultaneously process requests for a great number of tenants, and a given database table may store rows for multiple tenants.

In some implementations, the engines of environment 100 can be of varying types including workstations, servers, computing clusters, blade servers, server farms, or any other data processing systems or computing devices. The engine can be communicably coupled to the databases via a different network connection. For example, scoring engine 126 can be coupled via the network 115 (e.g., the Internet), influence engine 128 can be coupled via a direct network link, and analysis engine 140 can be coupled by yet a different network connection.

In some implementations, databases used in environment 100 can store information from one or more tenants into tables of a common database image to form a multi-tenant database system (MTS). A database image can include one or more database objects. In other implementations, the databases can be relational database management systems (RDBMSs), object oriented database management systems (OODBMSs), distributed file systems (DFS), no-schema database management systems, or any other data storing systems or computing devices.

While environment 100 is described herein with reference to particular blocks, it is to be understood that the blocks are defined for convenience of description and are not intended to require a particular physical arrangement of component parts. Further, the blocks need not correspond to physically distinct components. To the extent that physically distinct components are used, connections between components (e.g., for data communication) can be wired and/or wireless as desired. The different elements or components can be combined into single software modules and multiple software modules can run on the same hardware.

### User Engagement Console

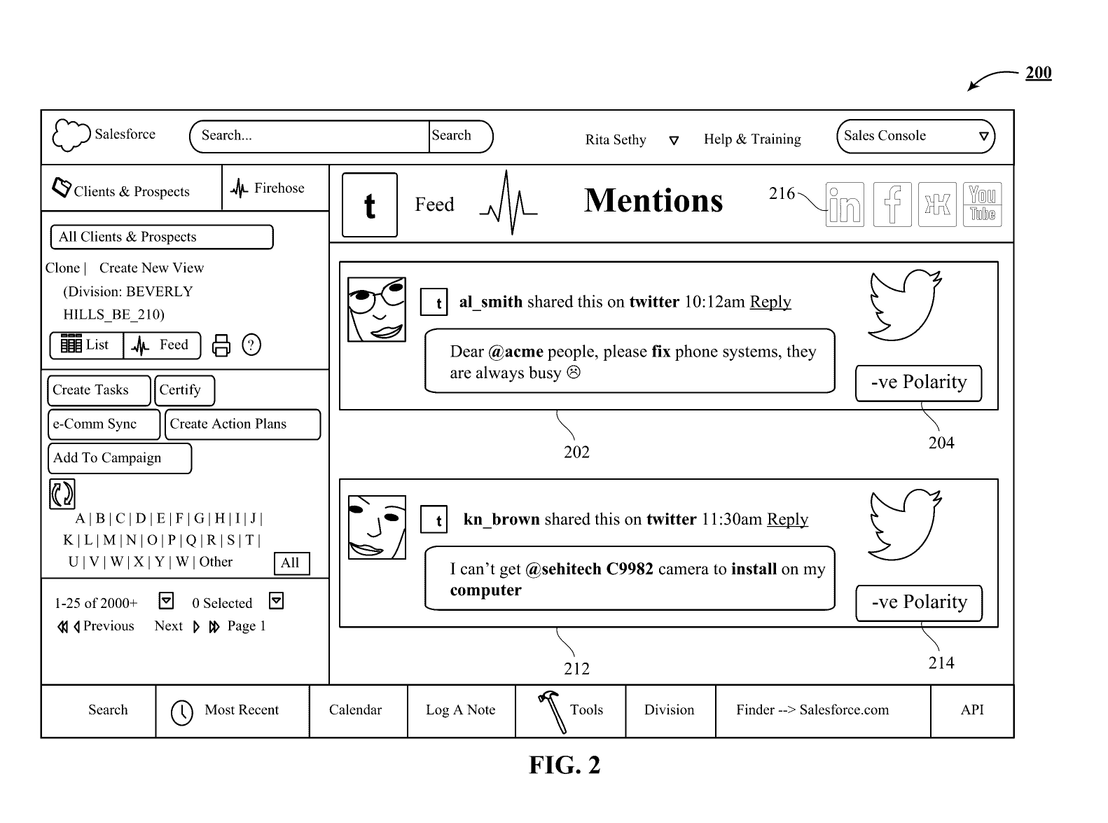

FIG. 2 illustrates one implementation of a user engagement console 200 used to run a user experience operation. Console 200 is exposed to a company representative who can access social media streams from different social networks. In FIG. 2, the company representative has selected the Twitter social media stream via its Firehose API. In other implementations, the company representative can access other social media streams 216 from other social networks like LinkedIn, Facebook, Klout and YouTube.

Further, the social media streams are received on an event-by-event basis such that an event is defined as a social media post made on a social network. Such social media posts are depicted as posts 202 and 212 in console 200 with their text and the users who made the posts. In addition, targeting parameters such as entity mentions and rave and rant words are also detected in the social media posts 202 and 212.

In the example shown in FIG. 2, a user named “Al Smith” posts a tweet 202 that says “Dear @acme people, please fix phone systems, they are always busy [symbol] ”. The technology disclosed uses data parser 137 and analysis engine 140 to determine the brand mentioned in tweet 202, i.e. Acme. Moreover, a negative polarity 204 of the tweet 202 is determined by applying deep linguistic analysis on the sentence level and phrase level of the text of tweet 202, and thus, as a result, Al Smith is identified as a detractor. Furthermore, a timestamp of receiving the tweet 202 is recorded, i.e. 10:12 am. In another example, another tweet 212 from a user named “Ken Brown” is received at 11:30 am relating to a camera product C9982 of Sehitech company. The tweet 202 is assigned a negative polarity 214, and thus, as a result, Ken Brown is identified as a detractor.

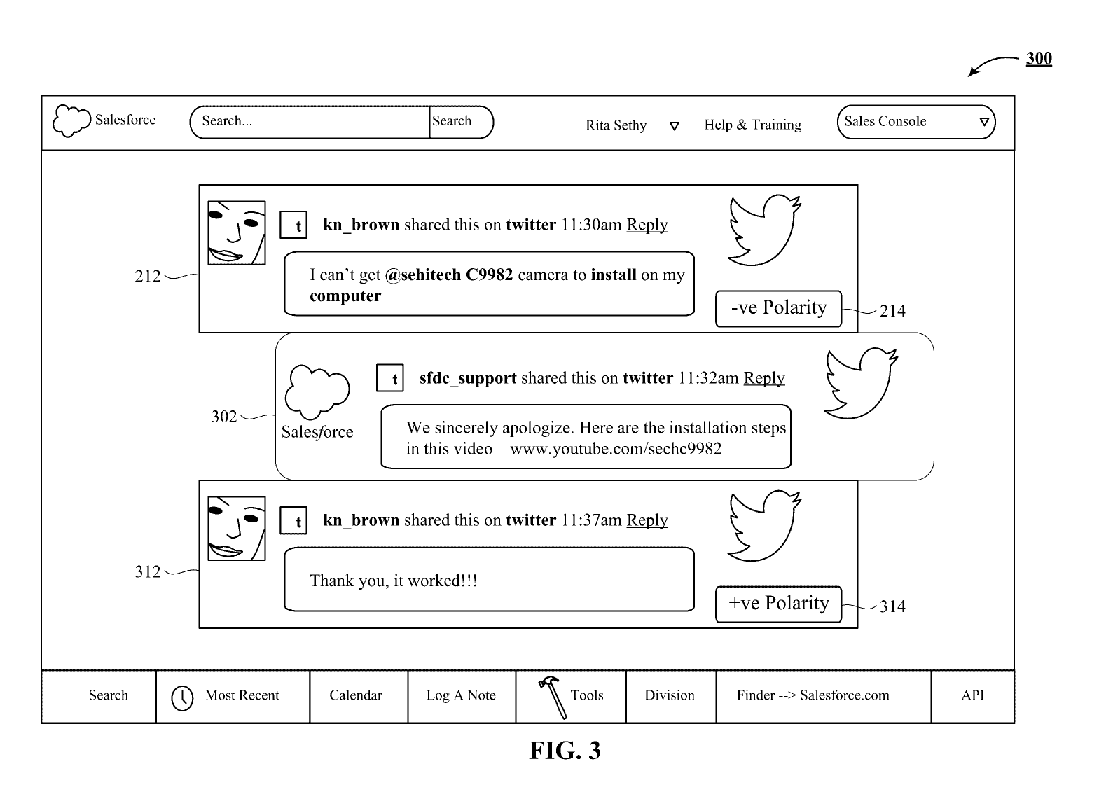

FIG. 3 is one implementation of an online social engagement 300 with a user named “Ken Brown” during the user experience operation illustrated in FIG. 2. In the example shown in FIG. 3, the initial polarity of social engagement 300, also referred to as the “global polarity”, is negative based on the negative polarity 214 of its latest tweet 212. The starting time of the global polarity of social engagement 300 is set as the time at which tweet 212 was posted i.e. 11:30 am. At 11:32 am, a company representative engages with user Ken Brown via another tweet 302 in an effort to resolve Ken Brown's issue identified in tweet 212. In response, Ken Brown posts tweet 312 at 11:37 am that indicates that Ken Brown is satisfied with the answer provided by the company representative in tweet 302, and thus, as a result, Ken Brown is identified as a promoter. Consequently, tweet 312 is assigned a positive polarity 314 and tweet 312 and being the latest social media post in social engagement 300 it changes the polarity of social engagement 300 to positive.

Moreover, the technology disclosed calculates the amount of time taken to turn-around the polarity of social engagement 300 from negative polarity 214 to positive polarity 314, i.e. approximately seven minutes in FIG. 3's example. In some implementations, this time determination can be used as a parameter of a performance metric used to determine efficiency and productivity of the company representative.

### Data Models

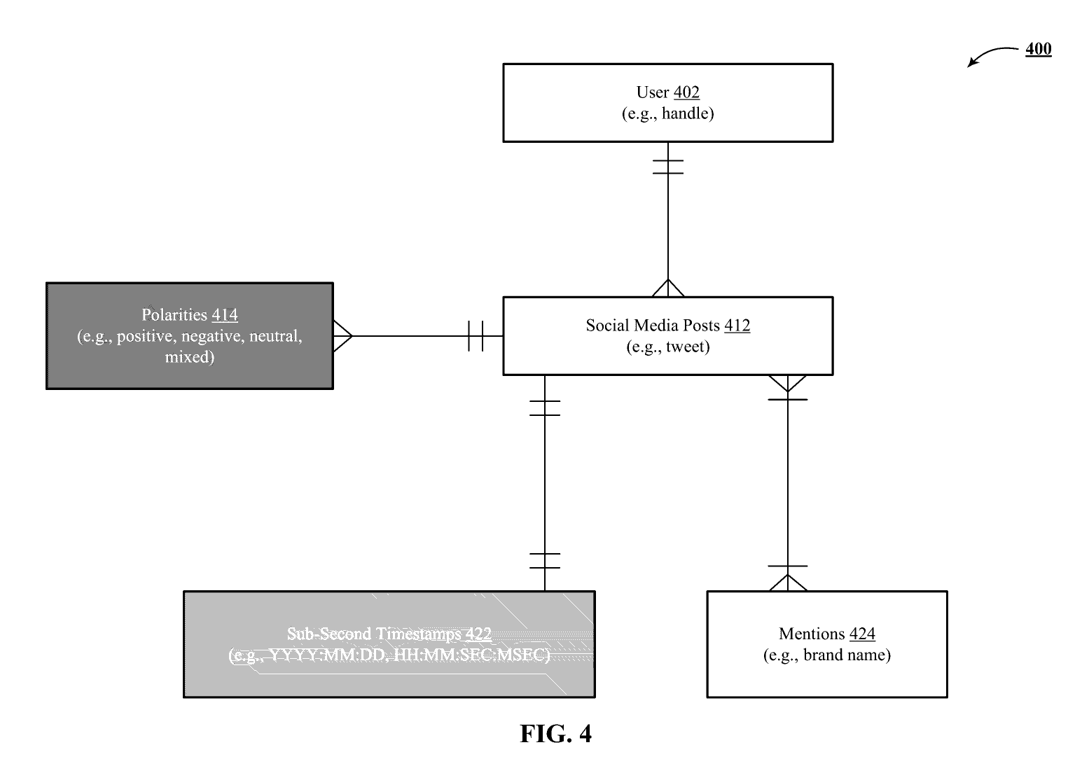

FIG. 4 shows a high level view of the data model 400 of a system in accordance with an implementation of the technology disclosed. Data model 400 serves as a schema that describes the organizing of social media data. The schema centers around two key questions: what is the polarity of a particular post and at what time a particular post was posted. In particular, FIG. 4 shows the relationship between user 402 (detected by a unique identifier such as Twitter handle), social media posts 412 (such as tweets), polarities 414 (e.g., positive, negative, neutral, mixed), sub-second timestamps 422 (e.g., YYYY:MM:DD, HH:MM:SEC:MSEC) and mentions 424 (e.g., brand name). The lines between these boxes, together with the notations at the line ends, describe the cardinality of the relationships, e.g., each user 402 is related to one or more social media posts 412; each social media post 412 includes one or more target parameters like mentions 424; each social media post 412 has at least one polarity 414; and each social media post 412 has exactly one sub-second timestamp 422.

The singular and the plural are used interchangeably in discussing the elements of FIG. 4 for clarity to better focus on describing the data model 400 which the diagram clearly describes.

FIG. 4 is only one possible data model used by an implementation; other data models may be used. It should be understood that the data model in FIG. 4 can be implemented in one or more databases, object relational mapping (ORM) systems, and/or any other appropriate data storage. If a SQL-style database is used, each box loosely corresponds to a table with rows of the tables containing the appropriate contents. For example, the users 402 could be stored as a table with one row per user, and an intermediate table would be used to connect the user table with the social media posts table to support the many-to-many relationship. In other data storage approaches, intermediate tables might not be required, and for that reason such intermediate, or join tables, are omitted from the data model of FIG. 4. The data and data model of FIG. 4 can be stored in the Cassandra cluster 116 or Hadoop cluster 118 and analyzed by analysis engine 140.

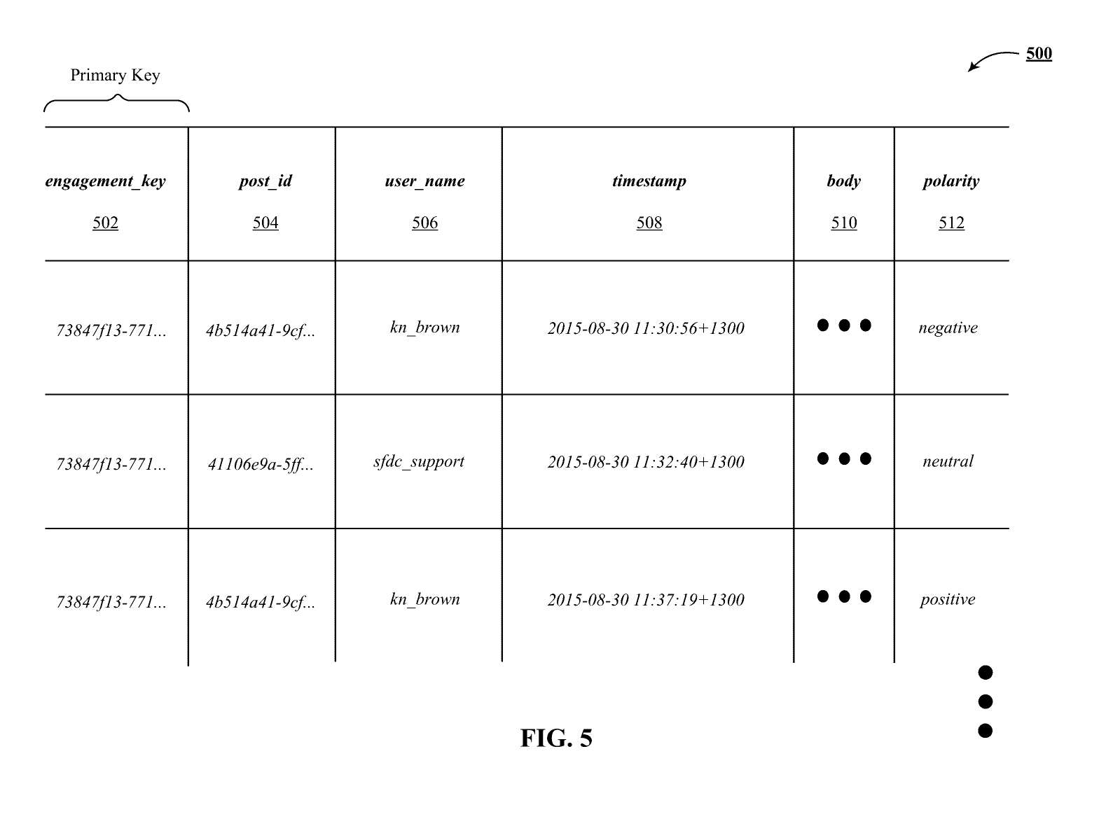

FIG. 5 illustrates social media data being stored in a Cassandra data model 500 in accordance with an implementation of the technology disclosed. Cassandra data model 500 uses the first column name as the partition key. For example, in FIG. 5, the “engagement_key” 502, which uniquely represents a social engagement, is the primary key and is used as a partitioning key that determines on which node C1-C8 of the Cassandra cluster 116 the social media posts of the social engagement are stored. Cassandra data model 500 also includes one or more additional columns that determine clustering, referred to as “clustering columns”. In FIG. 5, the “post_ID” 504 is the clustering column. The data for each partition is clustered by the remaining column or columns. On a physical mode, when rows for a partition key are stored in order based on the clustering columns, retrieval of rows is very efficient. For example, because the engagement_key in the Cassandra data model 500 is the partition key, all the posts for the engagement are clustered in the order of the post_ID column.

In one implementation, Cassandra data model 500 is created using a Cassandra Query Language (CQL) that defines a PRIMARY KEY for Twitter Firehose table using the following exemplary CQL definition in which the PRIMARY KEY is composed solely from the PARTITION KEY:

Firehose Table

CREATE TABLE Firehose (

| | |
|---|---|
| engagement_key | bigint, |
| post_id | bigint, |
| body | text, |
| user_name | text, |
| timestamp | timestamp, |
| polarity | text |
| PRIMARY KEY | (engagement_key) |

)

In another multi-level nested HashMap implementation, at the first level, the PARTITION KEY is associated with the rest of columns forming the PRIMARY KEY and the second level is the association between the PRIMARY KEY and the rest of the data. Thus, the association is PARTITION KEY->PRIMARY KEY->DATA and is represented by the following exemplary CQL definition:

Firehose Table

CREATE TABLE Firehose (

| | |
|---|---|
| engagement_key | bigint, |
| post_id | bigint, |
| body | text, |
| user_name | text, |
| timestamp | timestamp, |
| polarity | text |
| PRIMARY KEY | (engagement_key, post_id) |

)

Since Cassandra uses the PARTITION KEY to distribute data across the physical data partitions, nodes C1-C8, this allows querying on an engagement-by-engagement basis and post-by-post basis. As a result, posts with specific polarity from social engagements can be retrieved using an exemplary CQL shown below:
SELECT*FROM ENGAGEMENT_KEY WHERE POLARITY=“NEGATIVE”;

In one implementation, values for timestamp 508 are encoded as 64-bit signed integers representing a number of milliseconds in accordance with the standard base time known as the epoch: January 1 1970 at 00:00:00 GMT. Timestamp 508 can be entered as an integer for CQL input, or as a string literals in any of the following ISO 8601 formats:

yyyy-mm-dd HH:mm
yyyy-mm-dd HH:mm:ss
yyyy-mm-dd HH:mmZ
yyyy-mm-dd HH:mm:ssZ
yyyy-mm-dd′T′HH:mm
yyyy-mm-dd′T′HH:mmZ
yyyy-mm-dd′T′HH:mm:ss
yyyy-mm-dd′T′HH:mm:ssZ
yyyy-mm-dd
yyyy-mm-ddZ

In the formats above, Z is the RFC-822 4-digit time zone, expressing the time zone's difference from UTC. For example, for the date and time of Jan 2, 2003, at 04:05:00 AM, GMT:

2011-02-03 04:05+0000
2011-02-03 04:05:00+0000
2011-02-03T04:05+0000
2011-02-03T04:05:00+0000

If no time zone is specified, the time zone of the Cassandra node handing the write request is used.

### Opinion Polarity Turn-Around Time Calculation

In an implementation, the following exemplary CQL query is used to determine an opinion polarity turn-around time between social media posts during a social engagement:

SELECT * TIMESTAMP FROM ENGAGEMENT_KEY WHERE
POLARITY = “NEGATIVE” AS INITIAL POLARITY;
SELECT * TIMESTAMP FROM ENGAGEMENT_KEY WHERE
POLARITY = “POSITIVE” AS FINAL POLARITY;
SELECT FINAL POLARITY - INITIAL POLARITY AS TURN
AROUND TIME
ORDER TURN AROUND TIME BY ASC

In another implementation, LEAD and LAG analytic functions are used that provide values for preceding or following rows. In some implementations, a LAG function can take the following arguments:
LAG (expression)—this provides the value of expression calculated for a preceding row.
LAG (expression, number-of-rows)—this provides the value of expression calculated from the row that is number-of-rows before the current row.
LAG (expression, number-of-rows, value)—this provides the value of expression from number-of-rows prior with a specific value.

The example below shows another query implementation of calculating a turn-around time of opinion polarity of social media posts in a social engagement:

```
SELECT
    Polarity = “positive”,
    Timestamp,
    LAG(Timestamp) OVER (ORDER BY Timestamp) AS
    PriorRowEventTime WHERE Polarity = “negative” or “mixed” or
    “neutral”
FROM Firehose
ORDER BY Timestamp;
```

In the query implementation illustrated above, the PriorRowEventTime for each row is the Timestamp value for the row with a different polarity immediately preceding it. The Over (Order By Timestamp) clause gets the prior values as if the list were ordered by Timestamp.

In a further implementation, time span between two social media posts of varying opinion polarities is calculated using the following query definition:

```
SELECT
    Polarity = “positive”,
    Timestamp,
    Timestamp - LAG(Timestamp) OVER (ORDER BY Timestamp) AS
    Elapsed WHERE Polarity = “negative” or “mixed” or “neutral”
FROM Firehose;
```

In the query implementation illustrated above, the Elapsed function above represents a time span accurate to fraction seconds.

In a further implementation, the LAG function is further defined by partitioning. The following query definition limits the prior Timestamp value to rows that the a varying opinion polarity:

```
SELECT
    Polarity = “positive”,
    Timestamp,
    Timestamp - LAG(Timestamp) OVER (PARTITION BY Polarity =
    “negative” or “mixed” or “neutral” ORDER BY Timestamp) AS
    PriorRowEventTime
FROM Firehose
ORDER BY Timestamp;
```

In this case, the prior Timestamp comes from the row that has the most-recent preceding Timestamp and a differing opinion polarity.

The above implementations can also be applied using a LEAD function, defined using the following exemplary query:

```
SELECT
    Polarity = “negative”,
    Timestamp,
    Timestamp - LEAD(Timestamp) OVER (PARTITION BY Polarity =
    “positive” or “mixed” or “neutral” ORDER BY Timestamp) AS
    NextRowEventTime
FROM Firehose
ORDER BY Timestamp;
```

In the query implementation illustrated above, the NextRowEventTime for each row is the Timestamp value for the row with a different polarity immediately following it. The Over (Order By Timestamp) clause gets the following values as if the list were ordered by Timestamp.

In other implementations, Cassandra data model 500 identifies user names 506, the body 510 of the social media posts and their respective polarity 512, which can be incorporated as parameters in the query.

In other implementations, an average rate of change of opinion polarity is determined by calculating an average turn-around time and/or calculating an inverse of the average turn-around time.

The above implementations are only exemplary and can be similarly applied in another programming language, be it high-level programming language, low-level programming language, declarative programming language, functional programming language, markup programming language or imperative programming language, as listed supra or any other data model.

### Flowchart

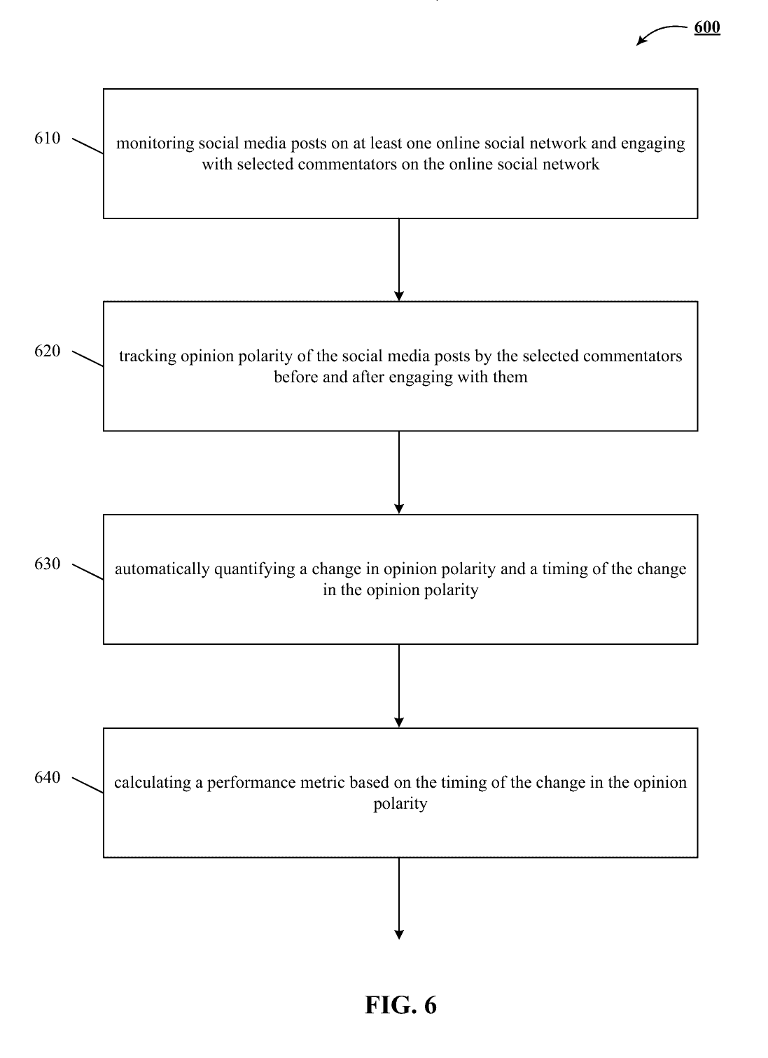

FIG. 6 shows one implementation of a flowchart 600 of measuring impact of social engagement on turn-around of social media opinion polarity. Flowchart 600 can be implemented at least partially with a computer or other data processing system, e.g., by one or more processors configured to receive or retrieve information, process the information, store results, and transmit the results. Other implementations may perform the actions in different orders and/or with different, fewer or additional actions than those illustrated in FIG. 6. Multiple actions can be combined in some implementations. For convenience, this workflow is described with reference to the system that carries out a method. The system is not necessarily part of the method.

At action 610, social media posts on at least one online social network are monitored and selected commentators on the online social network are engaged with. In one implementation, the selected commentators are selected based on their number of social media followers, as described supra. In some implementations, the selected commentators are selected based on their social media posts that include at least one of mentioned hashtags, mentioned usernames and mentioned domains of a brand, as described supra. In other implementations, social media posts of the selected commentators that include at least one of mentioned hashtags, mentioned usernames and mentioned domains of a brand are monitored, as described supra. In yet other implementations, posts on other interface categories, including access controlled APIs and public Internet are monitored, as described supra.

At action 620, opinion polarity of the social media posts by the selected commentators is tracked before and after engaging with them, as described supra. In some implementations, changes in opinion polarity among followers of the selected commentators are tracked, as described supra.

At action 630, a change in opinion polarity is quantified and a timing of the change in the opinion polarity is determined, as described supra. In one implementation, the opinion polarity classifies the social media posts as least one negative, positive, neutral or mixed associated opinion, as described supra.

At action 640, a performance metric is calculated based on the timing of the change in the opinion polarity, as described supra. Some examples of performance metrics include innovation (i.e. collaborating with users to drive future products and services), brand health (i.e. a measure of attributes, conversation and behavior towards a brand, user experience (improving relationship with users and their experience with a brand), operational efficiency (where and how a company reduces expenses) and revenue generation (where and how a company generates revenue).

### Multi-Tenant Integration

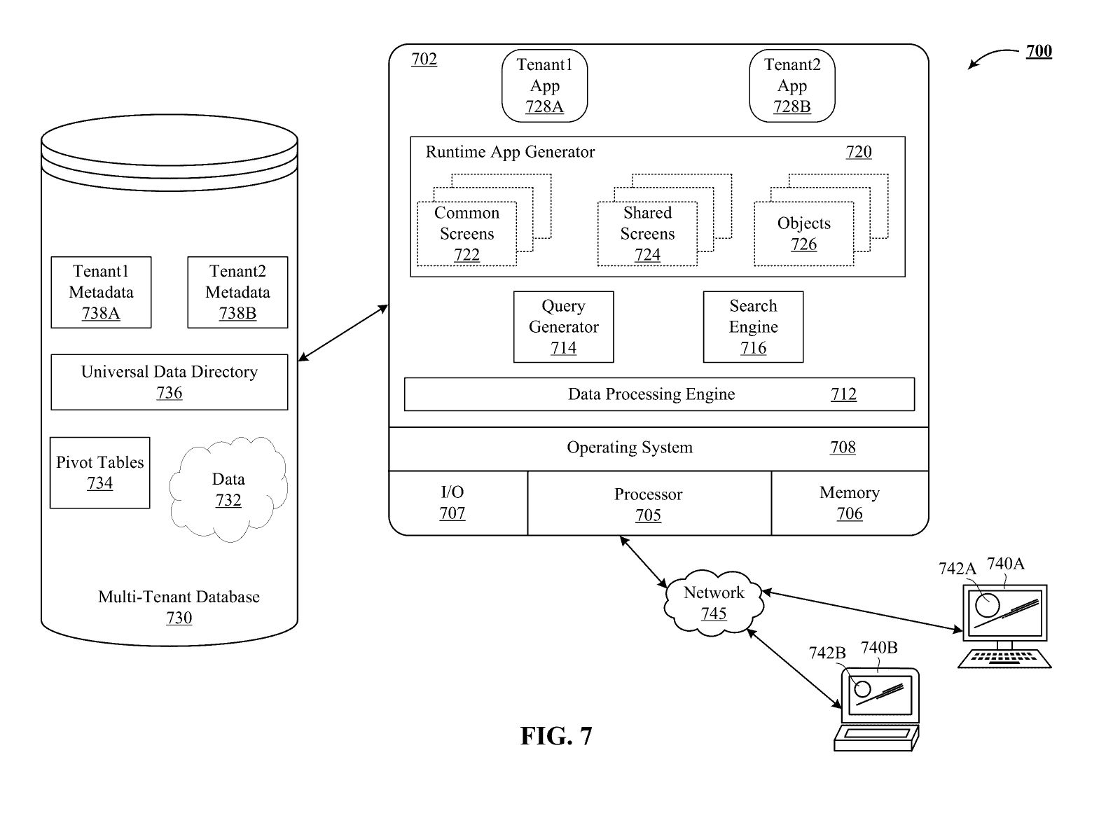

FIG. 7 is a block diagram of an exemplary multi-tenant system 700 suitable for integration with in the user experience management environment of FIG. 1 in accordance with one or more implementation.

Environment 100 of FIG. 1 can be implemented using a multi-tenant system. In that regard, FIG. 7 presents a conceptual block diagram of an exemplary multi-tenant system suitable for integration with the user experience environment of FIG. 1 in accordance with one or more implementations.

In general, the illustrated multi-tenant system 700 of FIG. 7 includes a server 702 that dynamically creates and supports virtual applications 728 based upon data 732 from a common database 730 that is shared between multiple tenants, alternatively referred to herein as a “multi-tenant database”. Data and services generated by the virtual applications 728 are provided via a network 745 to any number of client devices 740, as desired. Each virtual application 728 is suitably generated at run-time (or on-demand) using a common application platform 710 that securely provides access to the data 732 in the database 730 for each of the various tenants subscribing to the multi-tenant system 700. In accordance with one non-limiting example, the multi-tenant system 700 is implemented in the form of an on-demand multi-tenant user relationship management (CRM) system that can support any number of authenticated users of multiple tenants.

As used herein, a “tenant” or an “organization” should be understood as referring to a group of one or more users that shares access to common subset of the data within the multi-tenant database 730. In this regard, each tenant includes one or more users associated with, assigned to, or otherwise belonging to that respective tenant. Stated another way, each respective user within the multi-tenant system 700 is associated with, assigned to, or otherwise belongs to a particular tenant of the plurality of tenants supported by the multi-tenant system 700. Tenants may represent users, user departments, work or legal organizations, and/or any other entities that maintain data for particular sets of users within the multi-tenant system 700. Although multiple tenants may share access to the server 702 and the database 730, the particular data and services provided from the server 702 to each tenant can be securely isolated from those provided to other tenants. The multi-tenant architecture therefore allows different sets of users to share functionality and hardware resources without necessarily sharing any of the data 732 belonging to or otherwise associated with other tenants.

The multi-tenant database 730 is any sort of repository or other data storage system capable of storing and managing the data 732 associated with any number of tenants. The database 730 may be implemented using any type of conventional database server hardware. In various implementations, the database 730 shares processing hardware 504 with the server 702. In other implementations, the database 730 is implemented using separate physical and/or virtual database server hardware that communicates with the server 702 to perform the various functions described herein. In an exemplary implementation, the database 730 includes a database management system or other equivalent software capable of determining an optimal query plan for retrieving and providing a particular subset of the data 732 to an instance of virtual application 728 in response to a query initiated or otherwise provided by a virtual application 728. The multi-tenant database 730 may alternatively be referred to herein as an on-demand database, in that the multi-tenant database 730 provides (or is available to provide) data at run-time to on-demand virtual applications 728 generated by the application platform 310.

In practice, the data 732 may be organized and formatted in any manner to support the application platform 710. In various implementations, the data 732 is suitably organized into a relatively small number of large data tables to maintain a semi-amorphous “heap”-type format. The data 732 can then be organized as needed for a particular virtual application 728. In various implementations, conventional data relationships are established using any number of pivot tables 734 that establish indexing, uniqueness, relationships between entities, and/or other aspects of conventional database organization as desired. Further data manipulation and report formatting is generally performed at run-time using a variety of metadata constructs. Metadata within a universal data directory (UDD) 736, for example, can be used to describe any number of forms, reports, workflows, user access privileges, work logic and other constructs that are common to multiple tenants. Tenant-specific formatting, functions and other constructs may be maintained as tenant-specific metadata 338 for each tenant, as desired. Rather than forcing the data 732 into an inflexible global structure that is common to all tenants and applications, the database 730 is organized to be relatively amorphous, with the pivot tables 734 and the metadata 738 providing additional structure on an as-needed basis. To that end, the application platform 710 suitably uses the pivot tables 734 and/or the metadata 738 to generate “virtual” components of the virtual applications 728 to logically obtain, process, and present the relatively amorphous data 732 from the database 730.

The server 702 is implemented using one or more actual and/or virtual computing systems that collectively provide the dynamic application platform 710 for generating the virtual applications 728. For example, the server 702 may be implemented using a cluster of actual and/or virtual servers operating in conjunction with each other, typically in association with conventional network communications, cluster management, load balancing and other features as appropriate. The server 702 operates with any sort of conventional processing hardware 504, such as a processor 705, memory 706, input/output features 707 and the like. The input/output features 707 generally represent the interface(s) to networks (e.g., to the network 745, or any other local area, wide area or other network), mass storage, display devices, data entry devices and/or the like. The processor 705 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 706 represents any non-transitory short or long term storage or other computer-readable media capable of storing programming instructions for execution on the processor 705, including any sort of random access memory (RAM), read only memory (ROM), flash memory, magnetic or optical mass storage, and/or the like. The computer-executable programming instructions, when read and executed by the server 702 and/or processor 705, cause the server 702 and/or processor 705 to create, generate, or otherwise facilitate the application platform 710 and/or virtual applications 728 and perform one or more additional tasks, operations, functions, and/or processes described herein. It should be noted that the memory 706 represents one suitable implementation of such computer-readable media, and alternatively or additionally, the server 702 could receive and cooperate with external computer-readable media that is realized as a portable or mobile component or application platform, e.g., a portable hard drive, a USB flash drive, an optical disc, or the like.

The application platform 710 is any sort of software application or other data processing engine that generates the virtual applications 728 that provide data and/or services to the client devices 740. In a typical implementation, the application platform 710 gains access to processing resources, communications interfaces and other features of the processing hardware 504 using any sort of conventional or proprietary operating system 708. The virtual applications 728 are typically generated at run-time in response to input received from the client devices 740. For the illustrated implementation, the application platform 710 includes a bulk data processing engine 712, a query generator 714, a search engine 716 that provides text indexing and other search functionality, and a runtime application generator 720. Each of these features may be implemented as a separate process or other module, and many equivalent implementations could include different and/or additional features, components or other modules as desired.

The runtime application generator 720 dynamically builds and executes the virtual applications 728 in response to specific requests received from the client devices 740. The virtual applications 728 are typically constructed in accordance with the tenant-specific metadata 738, which describes the particular tables, reports, interfaces and/or other features of the particular application 728. In various implementations, each virtual application 728 generates dynamic web content that can be served to a browser or other client program 742 associated with its client device 740, as appropriate.

The runtime application generator 720 suitably interacts with the query generator 714 to efficiently obtain multi-tenant data 732 from the database 730 as needed in response to input queries initiated or otherwise provided by users of the client devices 740. In a typical implementation, the query generator 714 considers the identity of the user requesting a particular function (along with the user's associated tenant), and then builds and executes queries to the database 730 using system-wide metadata 736, tenant specific metadata 738, pivot tables 734, and/or any other available resources. The query generator 714 in this example therefore maintains security of the common database 730 by ensuring that queries are consistent with access privileges granted to the user and/or tenant that initiated the request. In this manner, the query generator 714 suitably obtains requested subsets of data 732 accessible to a user and/or tenant from the database 730 as needed to populate the tables, reports or other features of the particular virtual application 728 for that user and/or tenant.

Still referring to FIG. 7, the data processing engine 712 performs bulk processing operations on the data 732 such as uploads or downloads, updates, online transaction processing, and/or the like. In many implementations, less urgent bulk processing of the data 732 can be scheduled to occur as processing resources become available, thereby giving priority to more urgent data processing by the query generator 714, the search engine 716, the virtual applications 728, etc.

In exemplary implementations, the application platform 710 is utilized to create and/or generate data-driven virtual applications 728 for the tenants that they support. Such virtual applications 728 may make use of interface features such as custom (or tenant-specific) screens 724, standard (or universal) screens 722 or the like. Any number of custom and/or standard objects 726 may also be available for integration into tenant-developed virtual applications 728. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 732 associated with each virtual application 728 is provided to the database 730, as appropriate, and stored until it is requested or is otherwise needed, along with the metadata 738 that describes the particular features (e.g., reports, tables, functions, objects, fields, formulas, code, etc.) of that particular virtual application 728. For example, a virtual application 728 may include a number of objects 726 accessible to a tenant, wherein for each object 726 accessible to the tenant, information pertaining to its object type along with values for various fields associated with that respective object type are maintained as metadata 738 in the database 730. In this regard, the object type defines the structure (e.g., the formatting, functions and other constructs) of each respective object 726 and the various fields associated therewith.

With continued reference to FIG. 3, the data and services provided by the server 302 can be retrieved using any sort of personal computer, mobile telephone, tablet or other network-enabled client device 740 on the network 745. In an exemplary implementation, the client device 340 includes a display device, such as a monitor, screen, or another conventional electronic display capable of graphically presenting data and/or information retrieved from the multi-tenant database 730. Typically, the user operates a conventional browser application or other client program 742 executed by the client device 740 to contact the server 702 via the network 745 using a networking protocol, such as the hypertext transport protocol (HTTP) or the like. The user typically authenticates his or her identity to the server 702 to obtain a session identifier (“SessionID”) that identifies the user in subsequent communications with the server 702. When the identified user requests access to a virtual application 728, the runtime application generator 720 suitably creates the application at run time based upon the metadata 738, as appropriate. As noted above, the virtual application 728 may contain Java, ActiveX, or other content that can be presented using conventional client software running on the client device 740; other implementations may simply provide dynamic web or other content that can be presented and viewed by the user, as desired.

The foregoing description is merely illustrative in nature and is not intended to limit the implementations of the subject matter or the application and uses of such implementations. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary implementations described herein are not intended to limit the scope or applicability of the subject matter in any way.

For the sake of brevity, conventional techniques related to databases, social networks, user interfaces, and other functional aspects of the systems (and the individual operating components of the systems) may not be described in detail herein. In addition, those skilled in the art will appreciate that implementations may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Implementations of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an implementation of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary implementations, the subject matter described herein is implemented in conjunction with a virtual user relationship management (CRM) application in a multi-tenant environment.

### Some Particular Implementations

In one implementation, a method of measuring impact of social engagement on turn-around of social media opinion polarity is described. The method includes monitoring social media posts on at least one online social network and engaging with selected commentators on the online social network. In one implementation, the selected commentators are selected based on their number of social media followers. The method also includes tracking opinion polarity of the social media posts by the selected commentators before and after engaging with them. It further includes automatically quantifying a change in opinion polarity and a timing of the change in the opinion polarity.

The method described in this section and other sections of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this method can readily be combined with sets of base features identified as implementations such as terminology, introduction, user experience management environment, user engagement console, data models, some particular implementations, etc.

In some implementations, the selected commentators are selected based on their social media posts that include at least one of mentioned hashtags, mentioned usernames and mentioned domains of a brand.

In some implementations, changes in opinion polarity among followers of the selected commentators are tracked.

In one implementation, the opinion polarity classifies the social media posts as least one negative, positive, neutral or mixed associated opinion.

In other implementations, social media posts of the selected commentators that include at least one of mentioned hashtags, mentioned usernames and mentioned domains of a brand are monitored.

In yet other implementations, posts on other interface categories, including access controlled APIs and public Internet are monitored.

Other implementations of the method described in this section can include a non-transitory computer readable storage medium storing instructions executable by a processor to perform any of the methods described above. Yet another implementation of the method described in this section can include a system including memory and one or more processors operable to execute instructions, stored in the memory, to perform any of the methods described above.

In another implementation, a method of extracting work intelligence from social user care data is described. The method includes maintaining one or more pre-defined post tags linked to fields of a client-intelligence object, wherein the client-intelligence object holds a tag importance field that identifies how important a particular post tag is, an opinion category field that identifies contextual polarity of a particular post tag, an influence level field that specifies an influence level of a user posting social user care data associated with a particular post tag and a content category field that classifies a particular post tag into one or more work or product categories. The method further includes assembling social user care data from a plurality of interface categories using the post tags, wherein the post tags are client-specific and apply to interface categories that host one or more accounts of clients seeking the social user care data, receiving instructions from a client for extracting work intelligence from the assembled social user care data and responsive to the instructions, determining a ranked list of work interest post tags based on the client-intelligence object.

The method described in this section and other sections of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this method can readily be combined with sets of base features identified as implementations such as terminology, introduction, user experience management environment, user engagement console, data models, some particular implementations, etc.

In one implementation, the tag importance field represents a numerical scale of importance of the post tags. In another implementation, the opinion category field classifies the post tags into at least one of negative, positive, neutral and mixed associated opinion. In yet another implementation, the influence level field classifies the user posting social user care data into at least one of VIP influencer, super influencer and influencer.

In some implementation, the content category field includes at least one of work, product, brand, ingredients, finance, disaster, accident, education, entertainment, culture, environment, health, medical, pharma, hospitality, recreation, human interest, labor, law, crime, politics, religion, belief, social issues, sports, technology, internet, war and conflict category.

In one implementation, the client-intelligence object holds a priority field that identifies how significant a particular post tag is. In another implementation, the priority field represents at least one of high, medium and low priority of the post tags. In yet another implementation, determining the ranked list of work interest post tags further includes identifying most important and high priority post tags associated with social user care data posted by at least one of VIP influencer and super influencer.

In other implementations, determining the ranked list of work interest post tags further includes identifying post tags belonging to a content category most directly associated with the client. In yet another implementation, the post tags identify client reference in the social user care data.

In some implementations, the post tags apply to interface categories that include at least one of mentioned hashtags, mentioned usernames and mentioned domains of the client.

In yet other implementations, the method further includes using the client-intelligence object to assign triggers that automatically populate fields of a user relationship manager (CRM) and implement workflows that automatically drive a case process of the user relationship manager.

In a further implementation, the method includes automatically populating fields of the CRM by determining from the assembled social user care data at least one of a client reference, associated product or brand and associated content category using the post tags and linked fields of the client-intelligence object and including the client reference, associated product or brand and associated content category in the CRM.

In one implementation, the method includes automatically populating fields of the CRM by incorporating, in the CRM, knowledge or support articles related to at least one of the client reference, associated product or brand and associated content category.

In one implementation, the interface categories include access controlled APIs, public internet and online social networks.

Other implementations of the method described in this section can include a non-transitory computer readable storage medium storing instructions executable by a processor to perform any of the methods described above. Yet another implementation of the method described in this section can include a system including memory and one or more processors operable to execute instructions, stored in the memory, to perform any of the methods described above.

The terms and expressions employed herein are used as terms and expressions of description and not of limitation, and there is no intention, in the use of such terms and expressions, of excluding any equivalents of the features shown and described or portions thereof. In addition, having described certain implementations of the technology disclosed, it will be apparent to those of ordinary skill in the art that other implementations incorporating the concepts disclosed herein can be used without departing from the spirit and scope of the technology disclosed. Accordingly, the described implementations are to be considered in all respects as only illustrative and not restrictive.

What is claimed is:

1. A method of measuring impact of social engagement on turn-around of social media opinion polarity, the method including:
monitoring social media posts on at least one online social network and engaging with selected commentators on the online social network, wherein the selected commentators are selected based on their number of social media followers;
tracking opinion polarity of the social media posts by the selected commentators before and after engaging with them; and
automatically quantifying a change in opinion polarity and a timing of the change in the opinion polarity.

2. The method of claim 1, wherein the selected commentators are selected based on their social media posts that include at least one of mentioned hashtags, mentioned usernames and mentioned domains of a brand.

3. The method of claim 1, further including tracking changes in opinion polarity among followers of the selected commentators.

4. The method of claim 1, wherein the opinion polarity classifies the social media posts as least one negative, positive, neutral or mixed associated opinion.

5. The method of claim 1, further including monitoring social media posts of the selected commentators that include at least one of mentioned hashtags, mentioned usernames and mentioned domains of a brand.

6. The method of claim 1, further including monitoring posts on other interface categories, including access controlled APIs and public Internet.

7. The method of claim 1, further including calculating a performance metric based on the timing of the change in the opinion polarity.

8. A system including one or more processors coupled to memory, the memory loaded with computer instructions to measure impact of social engagement on turn-around of social media opinion polarity, the instructions, when executed on the processors, implement actions comprising:
monitoring social media posts on at least one online social network and engaging with selected commentators on the online social network, wherein the selected commentators are selected based on their number of social media followers;
tracking opinion polarity of the social media posts by the selected commentators before and after engaging with them; and
automatically quantifying a change in opinion polarity and a timing of the change in the opinion polarity.

9. The system of claim 8, wherein the selected commentators are selected based on their social media posts that include at least one of mentioned hashtags, mentioned usernames and mentioned domains of a brand.

10. The system of claim 8, further implementing actions comprising tracking changes in opinion polarity among followers of the selected commentators.

11. The system of claim 8, wherein the opinion polarity classifies the social media posts as least one negative, positive, neutral or mixed associated opinion.

12. The system of claim 8, further implementing actions comprising monitoring social media posts of the selected commentators that include at least one of mentioned hashtags, mentioned usernames and mentioned domains of a brand.

13. The system of claim 8, further implementing actions comprising monitoring posts on other interface categories, including access controlled APIs and public Internet.

14. The system of claim 8, further implementing actions comprising calculating a performance metric based on the timing of the change in the opinion polarity.

15. A non-transitory computer readable storage medium impressed with computer program instructions to measure impact of social engagement on turn-around of social media opinion polarity, the instructions, when executed on a processor, implement a method comprising:
monitoring social media posts on at least one online social network and engaging with selected commentators on the online social network, wherein the selected commentators are selected based on their number of social media followers;
tracking opinion polarity of the social media posts by the selected commentators before and after engaging with them; and
automatically quantifying a change in opinion polarity and a timing of the change in the opinion polarity.

16. The non-transitory computer readable medium of claim 15, wherein the selected commentators are selected based on their social media posts that include at least one of mentioned hashtags, mentioned usernames and mentioned domains of a brand.

17. The non-transitory computer readable medium of claim 15, implementing the method further comprising tracking changes in opinion polarity among followers of the selected commentators.

18. The non-transitory computer readable medium of claim 15, wherein the opinion polarity classifies the social media posts as least one negative, positive, neutral or mixed associated opinion.

19. The non-transitory computer readable medium of claim 15, implementing the method further comprising monitoring social media posts of the selected commentators that include at least one of mentioned hashtags, mentioned usernames and mentioned domains of a brand.

20. The non-transitory computer readable medium of claim 15, implementing the method further comprising monitoring posts on other interface categories, including access controlled APIs and public Internet.

21. A method of extracting work intelligence from social user care data, the method including:
maintaining one or more pre-defined post tags linked to fields of a client-intelligence object, wherein the client-intelligence object holds:
a tag importance field that identifies how important a particular post tag is;
an opinion category field that identifies contextual polarity of a particular post tag;
an influence level field that specifies an influence level of a user posting social user care data associated with a particular post tag; and
a content category field that classifies a particular post tag into one or more work or product categories;
assembling social user care data from a plurality of interface categories using the post tags, wherein the post tags are client-specific and apply to interface categories that host one or more accounts of clients seeking the social user care data;
receiving instructions from a client for extracting work intelligence from the assembled social user care data; and
responsive to the instructions, determining a ranked list of work interest post tags based on the client-intelligence object.

22. The method of claim 21, further including using the client-intelligence object to:
assign triggers that automatically populate fields of a user relationship manager (CRM); and
implement workflows that automatically drive a case process of the user relationship manager.

23. The method of claim 22, wherein automatically populating fields of the CRM further includes:
determining from the assembled social user care data at least one of a client reference, associated product or brand and associated content category using the post tags and linked fields of the client-intelligence object; and
including the client reference, associated product or brand and associated content category in the CRM.

24. The method of claim 23, wherein automatically populating fields of the CRM further includes:
incorporating, in the CRM, knowledge or support articles related to at least one of the client reference, associated product or brand and associated content category.
